(19) United States
(12) Patent Application Publication
(10) Pub. No.: US 2024/0219628 A1
(43) Pub. Date: Jul. 4, 2024

(54) OPTICAL DEVICE

(71) Applicant: Advanced Semiconductor Engineering, Inc., Kaohsiung (TW)

(72) Inventors: Jr-Wei LIN, Kaohsiung (TW); Mei-Ju LU, Kaohsiung (TW); Sin-Yuan MU, Kaohsiung (TW); Chia-Sheng CHENG, Kaohsiung (TW)

(73) Assignee: Advanced Semiconductor Engineering, Inc., Kaohsiung (TW)

(21) Appl. No.: 18/092,145

(22) Filed: Dec. 30, 2022

(51) Int. Cl. G02B 6/12

(52) U.S. Cl. CPC G02B 6/12004

(57) ABSTRACT

An optical device is provided. The optical device includes a first photonic component; a first electronic component at least partially over the first photonic component; and an optical connection element at least partially over the first photonic component, the optical connection element being separated from the first electronic component.

### BACKGROUND

### 1. Technical Field

The present disclosure relates generally to an optical device.

### 2. Description of the Related Art

Silicon photonics and optical engines with integration of at least an electronic IC (EIC) and a photonic IC (PIC) have advantages of high transmission speed and low power loss and thus are applied in various areas. Such integrated device requires transmission of optical signals between PICs.

### SUMMARY

In one or more embodiments, an optical device includes a first photonic component; a first electronic component at least partially over the first photonic component; and an optical connection element at least partially over the first photonic component, the optical connection element being separated from the first electronic component.

In one or more embodiments, an optical device includes a first photonic component including a first waveguide; a second photonic component including a second waveguide; and an optical coupling structure between the first photonic component and the second photonic component and configured to optically couple the first waveguide to the second waveguide.

In one or more embodiments, a photonic component including a first region and a second region; a first optical structure optically coupled to the first region of the photonic component; and a second optical structure optically coupled to the second region of the photonic component, wherein a density of input/output (I/O) terminals at the first region is greater than a density of I/O terminals at the second region.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIG. 1A illustrates a cross-sectional view of an optical device in accordance with some embodiments of the present disclosure;

FIG. 1B illustrates a top view of an optical device in accordance with some embodiments of the present disclosure;

FIG. 1C illustrates a top view of a portion of an optical device in accordance with some embodiments of the present disclosure;

FIG. 1D illustrates a prospective view of a portion of an optical device in accordance with some embodiments of the present disclosure;

FIG. 1E illustrates a prospective view of a portion of an optical device in accordance with some embodiments of the present disclosure;

FIG. 2A illustrates a cross-sectional view of a portion of an optical device in accordance with some embodiments of the present disclosure;

FIG. 2B illustrates a cross-sectional view of a portion of an optical device in accordance with some embodiments of the present disclosure;

FIG. 2C illustrates a cross-sectional view of a portion of an optical device in accordance with some embodiments of the present disclosure;

FIG. 2D illustrates a cross-sectional view of a portion of an optical device in accordance with some embodiments of the present disclosure;

FIG. 2E illustrates a cross-sectional view of a portion of an optical device in accordance with some embodiments of the present disclosure;

FIG. 3A illustrates a cross-sectional view of a portion of a photonic component in accordance with some embodiments of the present disclosure;

FIG. 3B illustrates a top view of a portion of a photonic component in accordance with some embodiments of the present disclosure;

FIG. 3C illustrates a cross-sectional view of a portion of an optical device in accordance with some embodiments of the present disclosure;

FIG. 3D illustrates a top view of a portion of an optical device in accordance with some embodiments of the present disclosure;

FIG. 4A illustrates a top view of an optical device in accordance with some embodiments of the present disclosure;

FIG. 4B illustrates a top view of an optical device in accordance with some embodiments of the present disclosure;

FIG. 4C illustrates a cross-sectional view of an optical device in accordance with some embodiments of the present disclosure;

FIG. 5A illustrates a cross-sectional view of an optical device in accordance with some embodiments of the present disclosure; and

FIG. 5B illustrates a cross-sectional view of an optical device in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

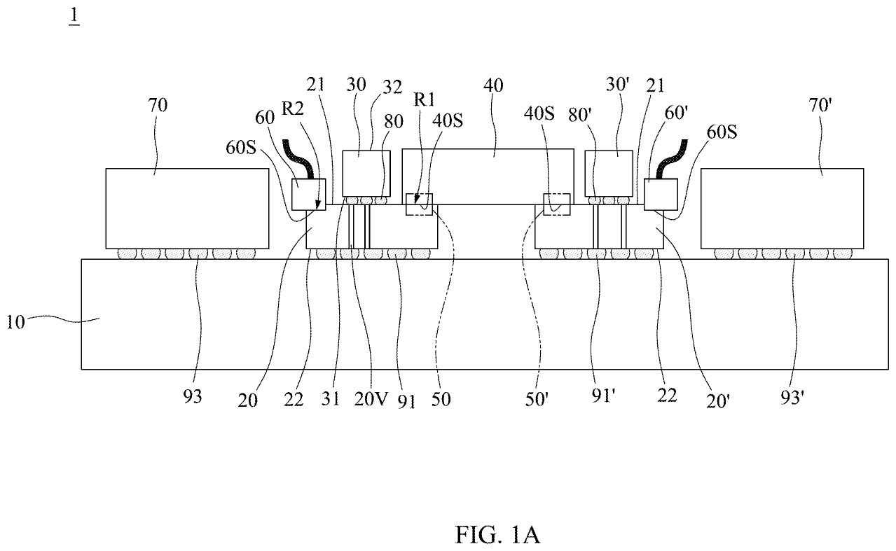

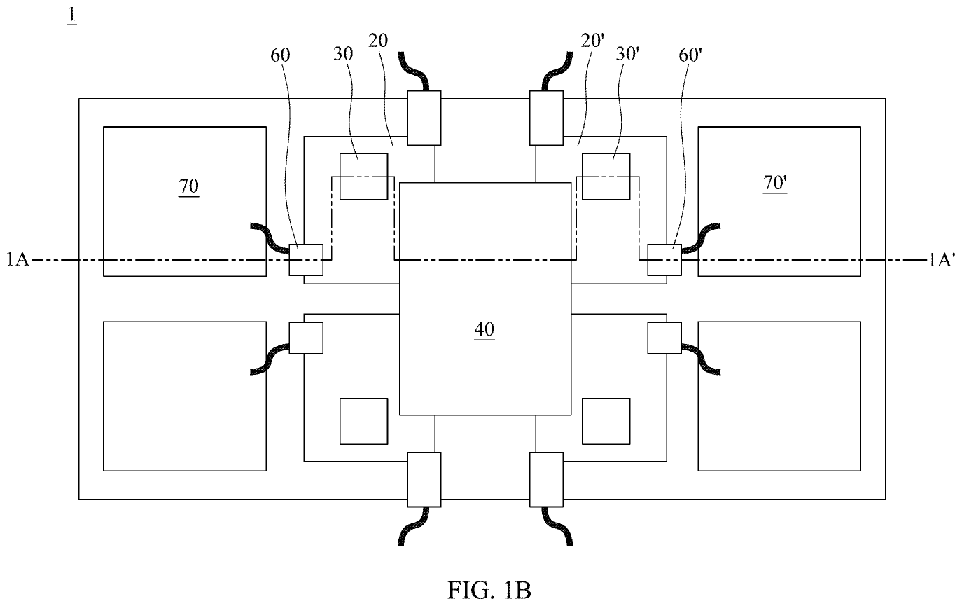

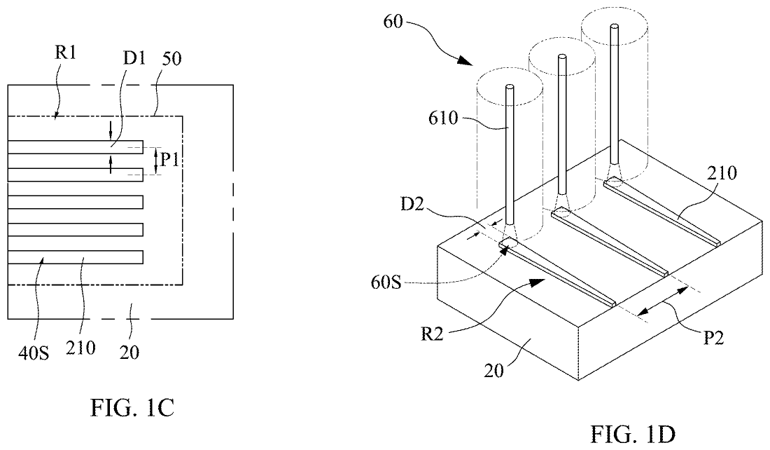

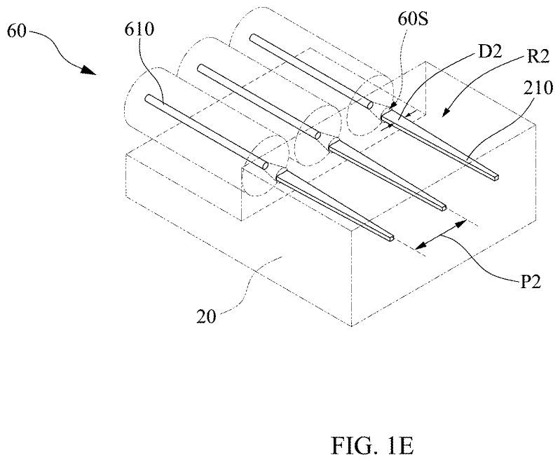

FIG. 1A illustrates a cross-sectional view of an optical device 1 in accordance with some embodiments of the present disclosure. FIG. 1B illustrates a top view of an optical device 1 in accordance with some embodiments of the present disclosure. In some embodiments, FIG. 1A is a cross-sectional view along a line 1A-1A′ in FIG. 1B. The optical device 1 includes a carrier 10, photonic components 20 and 20′, electronic components 30 and 30′, an optical connection element 40, optical coupling structures 50 and 50′, optical components 60 and 60′, processing components 70 and 70′, electrical connection elements 80 and 80′, and electrical contacts 91, 91′, 93, and 93′.

The carrier 10 may include, for example, a printed circuit board, such as a paper-based copper foil laminate, a composite copper foil laminate, or a polymer-impregnated glass-fiber-based copper foil laminate. The carrier 10 may include an interconnection structure, which may include such as a plurality of conductive traces and/or a plurality of conductive vias. The interconnection structure may include a redistribution layer (RDL) and/or a grounding element. In some embodiments, the carrier 10 includes a ceramic material or a metal plate. In some embodiments, the carrier 10 may include a substrate, such as an organic substrate or a leadframe. In some embodiments, the carrier 10 may include a two-layer substrate which includes a core layer and a conductive material and/or structure disposed on an upper surface and a bottom surface of the carrier 10. The conductive material and/or structure may include a plurality of traces. The carrier 10 may include one or more conductive pads in proximity to, adjacent to, or embedded in and exposed at an upper surface and/or a bottom surface of the carrier 10. The carrier 10 may include a solder resist (not shown) on the upper surface and/or the bottom surface of the carrier 10 to fully expose or to expose at least a portion of the conductive pads for electrical connections. In some embodiments, the carrier 10 supports the photonic components 20 and 20′, the electronic components 30 and 30′, the optical connection element 40, the optical components 60 and 60′, and the processing components 70 and 70′.

The photonic component 20 may be disposed over the carrier 10. The photonic component 20 may have a surface 21 (or a top surface) and a surface 22 (or a bottom surface) opposite to the surface 21. The surface 21 of the photonic component 20 may be an active surface. In some embodiments, the photonic component 20 includes one or more conductive vias 20V. The conductive via 20V may be configured to transmit an electrical signal from the surface 21 to the surface 22 of the photonic component 20. The photonic component 20 may be or include a photonic IC (PIC).

The photonic component 20′ may be disposed over the carrier 10. The photonic component 20′ may have a surface 21 (or a top surface) and a surface 22 (or a bottom surface) opposite to the surface 21. The surface 21 of the photonic component 20′ may be an active surface. In some embodiments, the photonic component 20′ includes one or more conductive vias 20V. The conductive via 20V may be configured to transmit an electrical signal from the surface 21 to the surface 22 of the photonic component 20′. The photonic component 20′ may be or include a PIC.

The electronic component 30 may be at least partially over the photonic component 20. In some embodiments, the electronic component 30 is disposed on the surface 21 of the photonic component 20. In some embodiments, the electronic component 30 is electrically connected to the photonic component 20. The electronic component 30 may have a surface 31 (e.g., an active surface) and a surface 32 opposite to the surface 31. In some embodiments, the active surface 31 of the electronic component 30 is electrically connected to the active surface 21 of the photonic component 20. The electronic component 30 may be or include an electronic IC (EIC). In some embodiments, the electronic component 30 includes an integrated digital signal processor (DSP), a transimpedance amplifier (TIA), a driver (DRV), or a combination thereof.

The electronic component 30′ may be at least partially over the photonic component 20′. In some embodiments, the electronic component 30′ is disposed on the surface 21 of the photonic component 20′. In some embodiments, the electronic component 30′ is electrically connected to the photonic component 20′. The electronic component 30′ may have a surface 31 (e.g., an active surface) and a surface 32 opposite to the surface 31. In some embodiments, the active surface 31 of the electronic component 30′ is electrically connected to the active surface 21 of the photonic component 20′. The electronic component 30′ may be or include an EIC. In some embodiments, the electronic component 30′ includes a DSP, a TIA, a DRV, or a combination thereof.

The optical connection element 40 (also referred to as “an optical structure”) may be at least partially over the photonic component 20. In some embodiments, the optical connection element 40 is disposed on the surface 21 of the photonic component 20. In some embodiments, the optical connection element 40 is optically coupled to the photonic component 20. In some embodiments, the optical connection element 40 is disposed over the photonic component 20′. In some embodiments, the optical connection element 40 is disposed on the surface 21 of the photonic component 20′. In some embodiments, the optical connection element 40 is optically coupled to the photonic component 20′. In some embodiments, the optical connection element 40 optically couples the photonic component 20 to the photonic component 20′. In some embodiments, the optical connection element 40 is disposed between the electronic component 30 and the electronic component 30′. In some embodiments, the optical connection element 40 is separated or distinct from the electronic components 30 and 30′. The optical connection element 40 may be configured as an optical bridge element to optically couple two or more photonic components. The optical connection element 40 may be or include a compact integrated waveguide ensemble (CIWE). In some embodiments, the optical connection element 40 is or includes a photonic component.

The optical coupling structure 50 may be formed or disposed between the photonic component 20 and the optical connection element 40. The optical connection element 40 may be optically coupled to the photonic component 20 through the optical coupling structure 50. The optical coupling structure 50′ may be formed or disposed between the photonic component 20′ and the optical connection element 40. The optical connection element 40 may be optically coupled to the photonic component 20′ through the optical coupling structure 50′.

The optical component 60 (also referred to as “an optical structure”) may be at least partially disposed on the photonic component 20. In some embodiments, the optical component 60 is connected to the photonic component 20. The optical component 60 may be connected to the photonic component 20 through a waveguide (not shown in FIG. 1A). In some embodiments, the electronic component 30 is disposed between the optical connection element 40 and the optical component 60 in a cross-sectional view. In some embodiments, the optical component 60 includes an optical fiber array component. In some embodiments, the optical fiber array component includes an integrated component including a plurality of fiber array units (FAUs). In some embodiments, the photonic component 20 includes an interface 40S configured to optically couple to the optical connection element 40. In some embodiments, the photonic component 20 further includes an interface 60S configured to optically couple to an external element (e.g., the optical component 60).

The optical component 60′ (also referred to as “an optical structure”) may be at least partially disposed on the photonic component 20′. In some embodiments, the optical component 60′ is connected to the photonic component 20′. The optical component 60′ may be connected to the photonic component 20′ through a waveguide (not shown in drawings). In some embodiments, the optical component 60′ includes an optical fiber array component. In some embodiments, the optical fiber array component includes an integrated component including a plurality of FAUs. In some embodiments, the photonic component 20′ includes an interface 40S configured to optically couple to the optical connection element 40. In some embodiments, the photonic component 20′ further includes an interface 60S configured to optically couple to an external element (e.g., the optical component 60′).

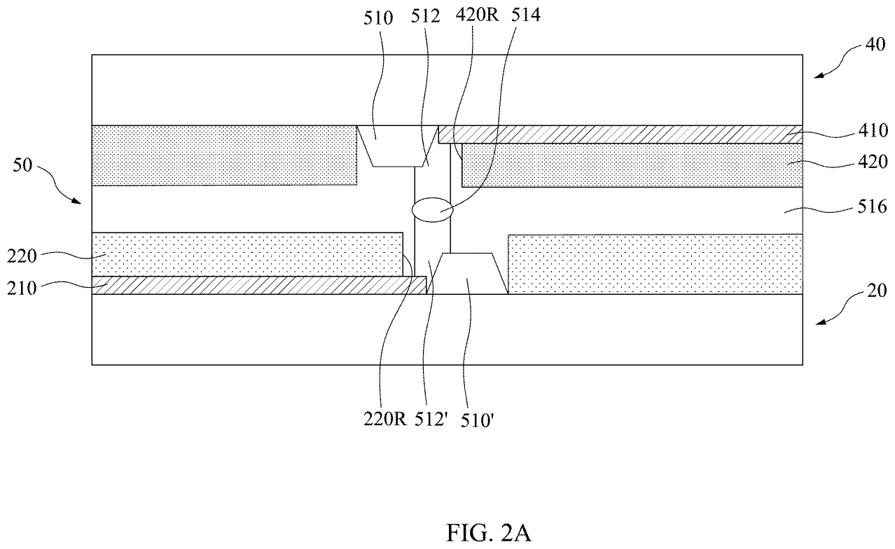

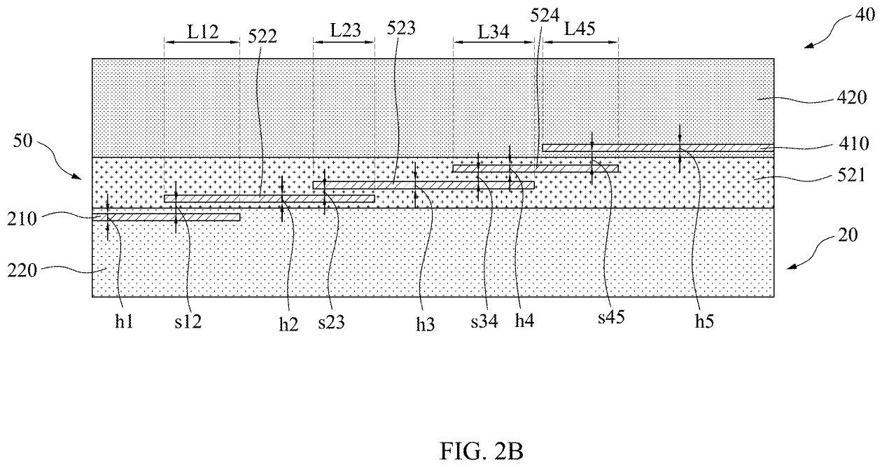

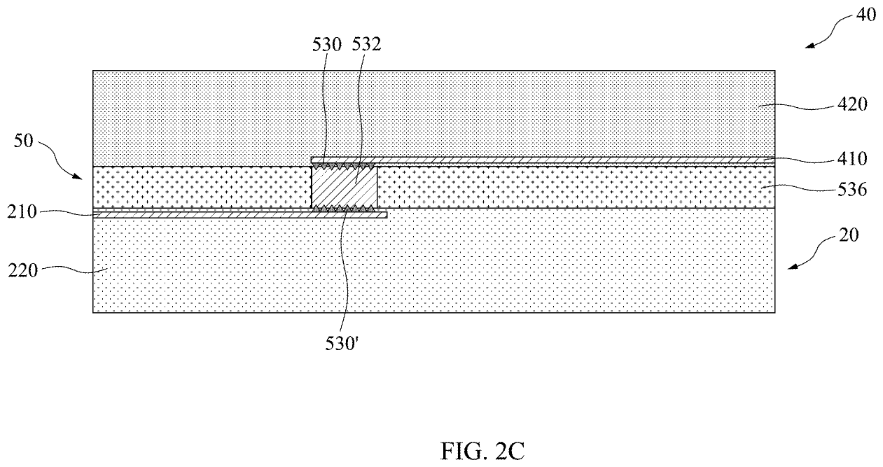

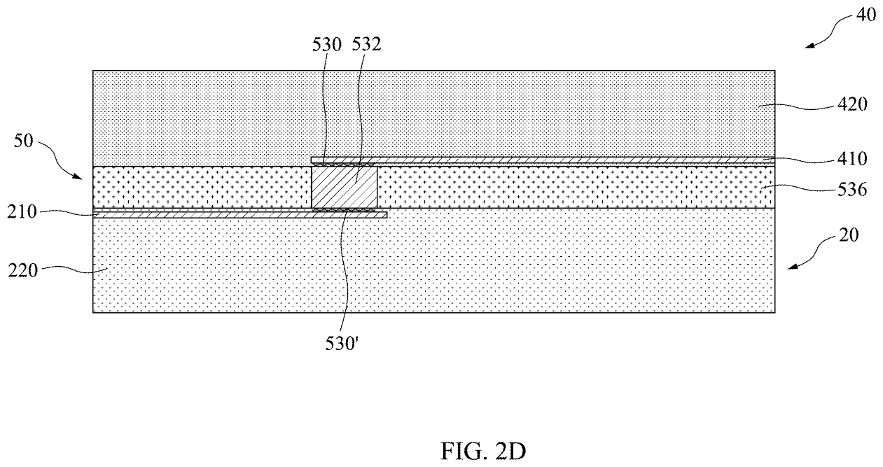

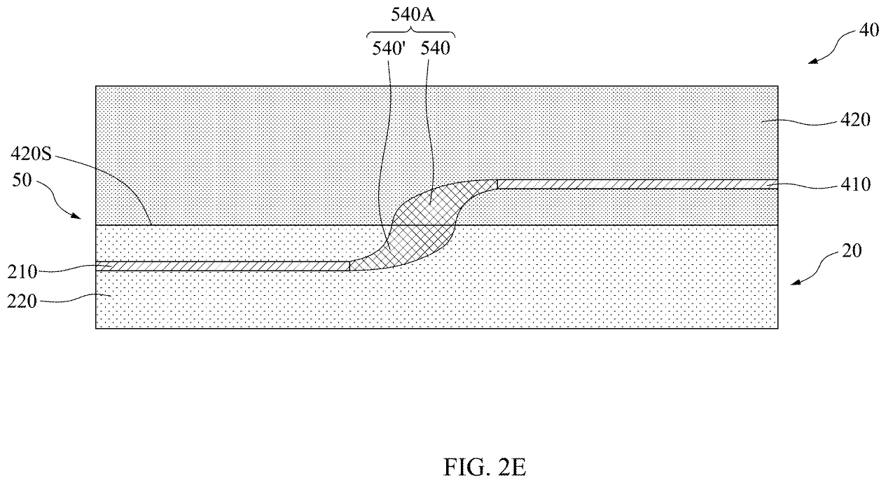

In some embodiments, the photonic component 20 includes a region R1 and a region R2. In some embodiments, the optical connection element 40 is optically coupled to the region R1 of the photonic component 20. In some embodiments, the optical component 60 is optically coupled to the region R2 of the photonic component 20. In some embodiments, the region R1 is configured to provide a different optical coupling type from the region R1. For example, the region R2 may be configured to provide a grating coupling or an edge coupling, and the region R1 may be configured to provide an optical coupling type different from a grating coupling and an edge coupling. For example, the region R1 may be configured to provide an optical coupling as illustrated in FIG. 1A, which will be discussed in details hereinafter. For example, the region R1 may be configured to provide an optical coupling as illustrated in FIGS. 2A to 2E, which will be discussed in details hereinafter. For example, the region R2 may be configured to provide an optical coupling as illustrated in FIGS. 1D to 1E, which will be discussed in details hereinafter.

The processing components 70 and 70′ may be disposed over the carrier 10. In some embodiments, the processing component 70 is electrically connected to the electronic component 30. In some embodiments, the processing component 70′ is electrically connected to the electronic component 30′. The processing component 70 and 70′ may independently include an ASIC, an FPGA, a GPU, or the like, or a combination thereof.

The electrical connection elements 80 may electrically connect the electronic component 30 to the photonic component 20. In some embodiments, the electrical connection elements 80 fasten the electronic component 30 to the photonic component 20. In some embodiments, the electrical connection elements 80′ electrically connect the electronic component 30′ to the photonic component 20′. In some embodiments, the electrical connection elements 80′ fasten the electronic component 30′ to the photonic component 20′. The electrical connection elements 80 and 80′ may be or include conductive bumps, solder balls, or the like. The electrical connection elements 80 and 80′ may include one or more conductive materials such as a metal or metal alloy. Examples include gold (Au), silver (Ag), aluminum (Al), copper (Cu), or an alloy thereof.

The electrical contacts 91 may be between the carrier 10 and the photonic component 20. In some embodiments, the conductive via 20V of the photonic component 20 is electrically connected to the carrier 10 through the electrical contact 91. The electrical contacts 91′ may be between the carrier 10 and the photonic component 20′. In some embodiments, the conductive via 20V of the photonic component 20′ is electrically connected to the carrier 10 through the electrical contact 91′. The electrical contacts 91 and 91′ may include controlled collapse chip connection (C4) bumps, a ball grid array (BGA), or a land grid array (LGA). The electrical contacts 91 and 91′ may include one or more conductive materials such as a metal or metal alloy. Examples include Au, Ag, Al, Cu, or an alloy thereof.

The electrical contacts 93 may be between the carrier 10 and the processing component 70. In some embodiments, the processing component 70 is electrically connected to the carrier 10 through the electrical contacts 93. The electrical contacts 93′ may be between the carrier 10 and the processing component 70′. In some embodiments, the processing component 70′ is electrically connected to the carrier 10 through the electrical contacts 93′. The electrical contacts 93 and 93′ may include C4 bumps, a BGA, or a LGA. The electrical contacts 93 may include one or more conductive materials such as a metal or metal alloy. Examples include Au, Ag, Al, Cu, or an alloy thereof.

FIG. 1C illustrates a top view of a portion of an optical device in accordance with some embodiments of the present disclosure, FIG. 1D illustrates a prospective view of a portion of an optical device in accordance with some embodiments of the present disclosure, and FIG. 1E illustrates a prospective view of a portion of an optical device in accordance with some embodiments of the present disclosure. In some embodiments, FIG. 1C illustrates a top view of a portion of the region R1 of the optical device 1. In some embodiments, FIG. 1D illustrates a prospective view of a portion of the region R2 of the optical device 1. In some embodiments, FIG. 1E illustrates a prospective view of a portion of the region R2 of the optical device 1.

As shown in FIG. 1C, in some embodiments, input-output (I/O) terminals (e.g., the waveguides 210) at the region R1 has a diameter D1 (e.g., a width). In some embodiments, the I/O terminals (or the waveguides 210) at the region R1 has a pitch P1. In some embodiments, the I/O terminals (or the waveguides 210) at the region R1 are optically coupled to the waveguides 410 of the optical connection element 40 through the interface 40S by the optical coupling structure 50. In some embodiments, the region R1 is configured to provide an optical coupling as illustrated in FIGS. 2A to 2E, which will be discussed in details hereinafter.

As shown in FIG. 1D, in some embodiments, I/O terminals (e.g., the waveguides 210) at the R2 has a diameter D2 (e.g., a width). In some embodiments, the I/O terminals (or the waveguides 210) at the region R2 has a pitch P2. In some embodiments, the region R2 is configured to provide a grating coupling. In some embodiments, the I/O terminals (or the waveguides 210) at the region R2 are optically coupled to the fibers 610 of the optical component 60 through grating coupling.

As shown in FIG. 1E, in some other embodiments, I/O terminals (e.g., the waveguides 210) at the R2 has a diameter D2 (e.g., a width). In some embodiments, the I/O terminals (or the waveguides 210) at the region R2 has a pitch P2. In some embodiments, the region R2 is configured to provide an edge coupling. In some embodiments, the I/O terminals (or the waveguides 210) at the region R2 are optically coupled to the fibers 610 of the optical component 60 through edge coupling.

In some embodiments, a density of the I/O terminals at the region R1 is greater than a density of the I/O terminals at the region R2. In some embodiments, the pitch P1 of the I/O terminals at the region R1 is less than the pitch P2 of the I/O terminals at the region R2. In some embodiments, the diameter D1 of one or the I/O terminals at the region R1 is less than the diameter D2 of one of the I/O terminals at the region R2.

In some cases where electronic and photonic components are integrated within one optical engine, optical signals are transmitted between optical engines by fibers or waveguides formed on a substrate, and thereby connections between transmitters (TX) and receivers (RX) of the optical engines may occupy relatively large areas. As such, the device areas and volumes are undesirably increased. In addition, since the waveguides are pre-formed on the substrate, the flexibility of packaging is relatively low.

In contrast, according to some embodiments of the present disclosure, the optical connection element may serve as an optical bridge element that optically couples photonic components. Therefore, the connections between the optical connection element and the photonic components may occupy relatively small areas. In addition, the arrangement of the optical connection element may vary according to the arrangements of the photonic components, and therefore the flexibility of packaging is significantly increased.

FIG. 2A illustrates a cross-sectional view of a portion of an optical device in accordance with some embodiments of the present disclosure. For example, FIG. 2A may illustrate a portion of the optical device 1 including the optical coupling structure 50. In some embodiments, FIG. 2A may illustrate a cross-sectional view of a portion of the optical device 1 including the optical coupling structure 50′ that optically couples the optical connection element 40 to the photonic component 20′.

In some embodiments, the photonic component 20 includes a waveguide 210 and a dielectric layer 220. In some embodiments, the waveguide 210 is partially embedded in the dielectric layer 220. In some embodiments, the dielectric layer 220 includes or defines a recess 220R, and a portion of the waveguide 210 is exposed by the recess 220R. In some embodiments, a refractive index of the waveguide 210 is equal to or greater than about 2.0, about 2.2, about 3, or about 3.5. The waveguide 210 may be or include silicon, silicon nitride (Si₃N₄), lithium niobate (LiNbO₃), or a combination thereof. In some embodiments, the waveguide 210 and the dielectric layer 220 may be formed by film deposition and lithography patterning processes. In some embodiments, a refractive index of the dielectric layer 220 is equal to or less than less than about 2.7, about 2.4, about 2, or about 1.5. The dielectric layer 220 may include silicon oxide. In some embodiments, the refractive index of the waveguide 210 is greater than the refractive index of the dielectric layer 220.

In some embodiments, the optical connection element 40 includes a waveguide 410 and a dielectric layer 420. In some embodiments, the waveguide 410 is partially embedded in the dielectric layer 420. In some embodiments, the dielectric layer 420 includes or defines a recess 420R, and a portion of the waveguide 410 is exposed by the recess 420R. In some embodiments, a refractive index of the waveguide 410 is equal to or greater than about 2.0, about 2.2, about 3, or about 3.5. The waveguide 410 may be or include silicon, silicon nitride (Si₃N₄), lithium niobate (LiNbO₃), or a combination thereof. In some embodiments, the waveguide 410 and the dielectric layer 420 may be formed by film deposition and lithography patterning processes. In some embodiments, a refractive index of the dielectric layer 420 is equal to or less than less than about 2.7, about 2.4, about 2, or about 1.5. The dielectric layer 420 may include silicon oxide. In some embodiments, the refractive index of the waveguide 410 is greater than the refractive index of the dielectric layer 420.

In some embodiments, the optical coupling structure 50 is between the photonic component 20 and the optical connection element 40. In some embodiments, the optical coupling structure 50 is configured to optically couple the waveguide 210 to the waveguide 410. In some embodiments, the optical coupling structure 50 includes an optical coupling element partially overlapping the waveguide 210 and the waveguide 410 vertically or from a top view perspective. The optical coupling element of the optical coupling structure 50 may include one or more light refractive elements, one or more light propagation elements, one or more bonding elements, one or more optically-transmissive elements, or a combination thereof.

In some embodiments, the optical coupling structure 50 includes light refractive elements 510 and 510′, light propagation elements 512 and 512′, a bonding element 514, and an optically-transmissive element 516.

In some embodiments, the light refractive element 510 is disposed in the recess 420R, and the light refractive element 510 is disposed in the recess 210R. In some embodiments, the light refractive elements 510 and 510′ are between the optical connection element 40 and the photonic component 20 and configured to direct a light to the waveguide 210 of the photonic component 20 and/or to the waveguide 410 of the optical connection element 40. In some embodiments, the light refractive elements 510 and 510′ are configured to direct a light from the waveguide 410 of the optical connection element 40 to the waveguide 210 of the photonic component 20. In some embodiments, the light refractive elements 510 and 510′ are configured to direct a light from the waveguide 210 of the photonic component 20 to the waveguide 410 of the optical connection element 40. In some embodiments, the light refractive elements 510 and 510′ may be or include optically-transmissive elements that are between and optically coupled to the optical connection element 40 and the photonic component 20. In some embodiments, the light refractive elements 510 and 510′ each includes a photoresist structure. In some embodiments, the light refractive elements 510 and 510′ each includes a negative-tone photoresist. In some embodiments, a refractive index of the light refractive element 510 is less than about 3, about 2.7, about 2.4, or about 2. In some embodiments, a refractive index of the light refractive element 510′ is less than about 3, about 2.7, about 2.4, or about 2. The refractive indexes of the light refractive elements 510 and 510′ may be the same or different depending on the actual applications.

In some embodiments, the light propagation element 512 contacts the waveguide 410, and the light propagation element 512′ contact the waveguide 210. In some embodiments, the light propagation element 512 and 512′ are between the optical connection element 40 and the photonic component 20 and configured to direct a light to the light refractive elements 510 and 510′. In some embodiments, the light refractive element 510 is configured to direct a transmission of light between the light propagation element 512 and the waveguide 410. In some embodiments, the light refractive element 510′ is configured to direct a transmission of light between the light propagation element 512′ and the waveguide 210. In some embodiments, the light propagation element 512 and 512′ define a light propagation direction substantially perpendicular to at least one of an extending direction of the waveguide 210 and an extending direction of the waveguide 410. In some embodiments, the light propagation element 512 and 512′ may be or include optically-transmissive elements that are between and optically coupled to the optical connection element 40 and the photonic component 20. In some embodiments, the light propagation element 512 and 512′ each includes a photoresist structure. In some embodiments, the light propagation element 512 and 512′ each is doped with high-refractive index particles, such as TiO₂ particles. In some embodiments, a refractive index of the light propagation element 512 is greater than about 1.5, about 2, about 2.4, or about 2.7. In some embodiments, a refractive index of the light refractive element 510′ is greater than about 1.5, about 2, about 2.4, or about 2.7. The refractive indexes of the light propagation elements 512 and 512′ may be the same or different depending on the actual applications. In some embodiments, the refractive indexes of the light refractive elements 510 and 510′ are less than the refractive indexes of the light propagation element 512 and 512′.

In some embodiments, the bonding element 514 contacts the light propagation element 512 and the light propagation element 512′. In some embodiments, the bonding element 514 connects or bonds the light propagation element 512 to the light propagation element 512′. In some embodiments, the bonding element 514 is between the optical connection element 40 and the photonic component 20 and configured to direct a light between the light propagation element 512 and 512′. In some embodiments, the bonding element 514 defines a light propagation direction substantially perpendicular to an extending direction of the waveguide 210, an extending direction of the waveguide 410, or both. In some embodiments, the bonding element 514 may be or include an optically-transmissive element that is between and optically coupled to the optical connection element 40 and the photonic component 20. In some embodiments, the bonding element 514 includes an adhesive layer. In some embodiments, the bonding element 514 includes a polymer structure, such as a thermal-cured polymer or a UV-cured polymer (e.g., an epoxy polymer). In some embodiments, a refractive index of the bonding element 514 is greater than about 1.5, about 2, about 2.4, or about 2.7. The refractive indexes of the light propagation elements 512 and 512′ and the refractive index of the bonding element 514 may be the same or different depending on the actual applications. In some embodiments, the refractive indexes of the light refractive elements 510 and 510′ are less than the refractive index of the bonding element 514.

In some embodiments, the optically-transmissive element 516 is between the photonic component 20 and the optical connection element 40. In some embodiments, the optically-transmissive element 516 covers the light propagation elements 512 and 512′. In some embodiments, the optically-transmissive element 516 further covers the light refractive elements 510 and 510′ and the bonding element 514. In some embodiments, the optically-transmissive element 516 is filled between the dielectric layer 220 and the dielectric layer 420. In some embodiments, a refractive index of the optically-transmissive element 516 is less than about 3, about 2.7, about 2.4, about 2, about 1.8, or about 1.5. In some embodiments, the refractive index of the optically-transmissive element 516 is less than the refractive indexes of the light propagation elements 512 and 512′. In some embodiments, the optically-transmissive element 516 includes air, an inorganic dielectric layer, a polymer layer, or a combination thereof.

The light refractive element 510 may be configured to alter or adjust a light propagation path of a light from the waveguide 210. In some embodiments, the light transmitted in the waveguide 210 may reach and be reflected by the light refractive element 510 so as to change its propagation path (or its propagation direction) toward the light propagation element 512. Then, the light may be transmitted through the light propagation element 512, the bonding element 514, and the light propagation element 512′ in turns and reach the light refractive element 510′. The light refractive element 510′ may be configured to alter or adjust a light propagation path of a light from the light propagation elements 512 and 512′. In some embodiments, the light transmitted in the light propagation elements 512 and 512′ may reach and be reflected by the light refractive element 510′ so as to change its propagation path (or its propagation direction) toward the waveguide 410. According to the design of the light refractive elements 510 and 510′ and the light propagation elements 512 and 512′, a light may be optically coupled between the waveguide 210 of the photonic component 20 and the waveguide 410 of the optical connection element 40 by altering or adjusting the propagation path (or the propagation direction) of the light.

FIG. 2B illustrates a cross-sectional view of a portion of an optical device in accordance with some embodiments of the present disclosure. For example, FIG. 2B may illustrate a portion of the optical device 1 including the optical coupling structure 50. In some embodiments, FIG. 2B may illustrate a cross-sectional view of a portion of the optical device 1 including the optical coupling structure 50′ that optically couples the optical connection element 40 to the photonic component 20′.

In some embodiments, the waveguide 210 is embedded in the dielectric layer 220. In some embodiments, the waveguide 410 is embedded in the dielectric layer 420.

In some embodiments, optical coupling element of the optical coupling structure 50 includes an optically-transmissive element 521 and a plurality of waveguide elements (e.g., waveguide elements 522, 523, and 524) between the photonic component 20 and the optical connection element 40. In some embodiments, the optically-transmissive element 521 connects the dielectric layer 220 to the dielectric layer 420. In some embodiments, a thickness h1 of the waveguide 210, a thickness h2 of the waveguide element 522, a thickness h3 of the waveguide element 523, a thickness h4 of the waveguide element 524, and a thickness h5 of the waveguide 410 may be the same or different. The number of the waveguide elements may vary according to actual applications and is not limited thereto.

In some embodiments, the optically-transmissive element 521 is between and optically coupled to the optical connection element 40 and the photonic component 20. In some embodiments, the optically-transmissive element 521 covers the waveguide elements 522, 523, and 524. In some embodiments, a refractive index of the optically-transmissive element 521 is less than about 2.7, about 2.4, about 2, or about 1.5. In some embodiments, a refractive index of the optically-transmissive element 521 is from about 1.31 to about 1.55. In some embodiments, the refractive index of the optically-transmissive element 521 is less than refractive indexes of the waveguide elements 522, 523, and 524. In some embodiments, the optically-transmissive element 521 includes an inorganic dielectric layer (e.g., silicon oxide), a polymer layer, or a combination thereof.

In some embodiments, the waveguide elements 522, 523, and 524 are between the optical connection element 40 and the photonic component 20 and configured to gradually direct a light to the waveguide 210 of the photonic component 20. In some embodiments, the waveguide elements 522, 523, and 524 are configured to gradually direct a light to the waveguide 410 of the optical connection element 40. In some embodiments, a light is coupled from the waveguide 210 through the waveguide elements 522, 523, and 524 one by one to the waveguide 410, or from the waveguide 410 through the waveguide elements 522, 523, and 524 one by one to the waveguide 210. In some embodiments, each of the waveguide elements 522, 523, and 524 is arranged one by one to transmit a light from the waveguide 210 through the waveguide elements 522, 523, and 524 to the waveguide 410, or from the waveguide 421 through the waveguide elements 522, 523, and 524 to the waveguide 210. In some embodiments, a light propagation path between two adjacent waveguide elements defines a light propagation direction substantially perpendicular to an extending direction of the waveguide elements 522, 523, and 524. For example, a light propagation path between the waveguide elements 522 and 523 is substantially perpendicular to an extending direction of the waveguide elements 522 and 523.

Each of the waveguides 210 and 410 and an adjacent waveguide element (e.g., the waveguide element 522 or 524) may partially overlap vertically or from a top view perspective. In some embodiments, the waveguide 210 and the waveguide element 522 partially overlap by an overlapping length L12 (also referred to as “a coupling length” or “a coupling coverage”) vertically or from a top view perspective. In some embodiments, the waveguide 410 and the waveguide element 524 partially overlap by an overlapping length L45 vertically or from a top view perspective. Every two adjacent waveguides elements may partially overlap vertically or from a top view perspective. In some embodiments, the waveguide elements 522 and 523 partially overlap by an overlapping length L23 vertically or from a top view perspective with an overlapping length L12, and the waveguide elements 523 and 524 partially overlap by an overlapping length L34 vertically or from a top view perspective. The coupling lengths may be adjusted to adjust the phase (e.g., π, π/2, or π/4) of the transmitted light.

Every adjacent waveguide (or waveguide elements) may be spaced apart from each other by a coupling distance (also referred to as “a coupling pitch”). In some embodiments, the waveguide 210 and the waveguide element 522 are spaced apart from each other by a coupling distance s12. In some embodiments, the waveguide element 522 and the waveguide element 523 are spaced apart from each other by a coupling distance s23. In some embodiments, the waveguide element 523 and the waveguide element 524 are spaced apart from each other by a coupling distance s34. In some embodiments, the waveguide 410 and the waveguide element 524 are spaced apart from each other by a coupling distance s45. The coupling distances s12, s23, s34, and s34 may be the same or different.

In some embodiments, the waveguide elements 522, 523, and 524 may be or include optically-transmissive elements that are between and optically coupled to the optical connection element 40 and the photonic component 20. In some embodiments, a refractive index of each of the waveguide elements 522, 523, and 524 is equal to or greater than about 2.0, about 2.2, about 3, or about 3.5. The waveguide elements 522, 523, and 524 may be or include silicon, silicon nitride (Si₃N₄), lithium niobate (LiNbO₃), or a combination thereof. In some embodiments, the waveguide elements 522, 523, and 524 and the dielectric layer 521 may be formed by film deposition and lithography patterning processes. Such processes are compatible with the processes for forming the waveguides 210 and 410 and the dielectric layers 220 and 420, and thus the manufacturing process of the optical device is simplified.

The waveguide elements 522, 523, and 524 may be configured as a multi-channel directional coupler that optically couples the photonic component 20 to the optical connection element 40. The partially overlapped waveguide elements 522, 523, and 524 may be configured to vertically couple a light between the photonic component 20 and the optical connection element 40. As the coupling lengths and/or the coupling pitches being relatively small can increase the optical coupling efficiency, the difficulty and complexity of the manufacturing process can be increased significantly. According to some embodiments of the present disclosure, by adjusting the coupling lengths and/or the coupling pitches, the difficulty and complexity of the manufacturing process can be lowered while the optical coupling between the photonic component 20 and the optical connection element 40 can be achieved to a satisfactory extent.

FIG. 2C illustrates a cross-sectional view of a portion of an optical device in accordance with some embodiments of the present disclosure. For example, FIG. 2C may illustrate a portion of the optical device 1 including the optical coupling structure 50. In some embodiments, FIG. 2C may illustrate a cross-sectional view of a portion of the optical device 1 including the optical coupling structure 50′ that optically couples the optical connection element 40 to the photonic component 20′.

In some embodiments, the optical coupling structure 50 (or the optical coupling element of the optical coupling structure 50) includes optical coupling elements 530 and 530′, an optical interposer 532, and an optically-transmissive element 536.

In some embodiments, the optical coupling element 530 is on or over the waveguide 410. In some embodiments, the optical coupling element 530 at least partially overlaps the waveguide 410 vertically or from a top view perspective. In some embodiments, the optical coupling element 530′ is on or over the waveguide 210. In some embodiments, the optical coupling element 530′ at least partially overlaps the waveguide 210 vertically or from a top view perspective. In some embodiments, the optical coupling element 530 and the optical coupling element 530′ at least partially overlap vertically or from a top view perspective. In some embodiments, the optical coupling elements 530 and 530′ (which may be collectively referred to as “an optical structure”) are between the optical connection element 40 and the photonic component 20 and configured to gradually direct a light to the waveguide 210 of the photonic component 20. In some embodiments, the optical coupling elements 530 and 530′ are configured to gradually direct a light to the waveguide 410 of the optical connection element 40.

In some embodiments, the optical coupling elements 530 and 530′ each includes an optical microstructure. In some embodiments, the optical coupling elements 530 and 530′ each includes a grating coupler. In some embodiments, a refractive index of the optical coupling element 530 and a refractive index of the optical coupling element 530′ are equal to or less than less than about 2.7, about 2.4, about 2, or about 1.5.

In some embodiments, the optical interposer 532 is between the optical coupling element 530 and the optical coupling element 530′. In some embodiments, the optical coupling element 530 and the optical coupling element 530′ partially extend into the optical interposer 532. In some embodiments, a light is transmitted or coupled from the waveguide 210 through the optical coupling element 530′, the optical interposer 532, and the optical coupling element 530 to the waveguide 410. In some embodiments, the optical interposer 532 includes a polymer structure, such as a thermal-cured polymer or a UV-cured polymer (e.g., an epoxy polymer). In some embodiments, a refractive index of the optical interposer 532 is equal to or greater than about 2.0, about 2.2, about 3, or about 3.5. In some embodiments, the refractive index of the optical coupling element 530 and the refractive index of the optical coupling element 530′ are less than a refractive index of the optical interposer 532.

In some embodiments, the optically-transmissive element 536 is between and optically coupled to the optical connection element 40 and the photonic component 20. In some embodiments, the optically-transmissive element 536 includes an inorganic dielectric layer (e.g., silicon oxide), a polymer layer, or a combination thereof.

The optical coupling element 530 and 530′ may be configured to optically couple the photonic component 20 to the optical connection element 40. The overlapped optical coupling element 530 and 530′ may be configured to vertically couple a light between the photonic component 20 and the optical connection element 40.

FIG. 2D illustrates a cross-sectional view of a portion of an optical device in accordance with some embodiments of the present disclosure. For example, FIG. 2D may illustrate a portion of the optical device 1 including the optical coupling structure 50. In some embodiments, FIG. 2D may illustrate a cross-sectional view of a portion of the optical device 1 including the optical coupling structure 50′ that optically couples the optical connection element 40 to the photonic component 20′.

The structure illustrated in FIG. 2D is similar to that illustrated in FIG. 2C, and the difference is that the optical coupling element 530 and the optical coupling element 530′ do not extend into the optical interposer 532.

FIG. 2E illustrates a cross-sectional view of a portion of an optical device in accordance with some embodiments of the present disclosure. For example, FIG. 2E may illustrate a portion of the optical device 1 including the optical coupling structure 50. In some embodiments, FIG. 2E may illustrate a cross-sectional view of a portion of the optical device 1 including the optical coupling structure 50′ that optically couples the optical connection element 40 to the photonic component 20′.

In some embodiments, the optical coupling structure 50 (or the optical coupling element of the optical coupling structure 50) includes a gradient index structure 540A between and optically coupled to the optical connection element 40 and the photonic component 20. In some embodiments, the gradient index structure 540A contacts the waveguide 210 and the waveguide 410. In some embodiments, the gradient index structure 540A is configured to gradually direct a light to the waveguide 210 of the photonic component 20. In some embodiments, the gradient index structure 540A is configured to gradually direct a light to the waveguide 410 of the optical connection element 40.

In some embodiments, the gradient index structure 540A has a refractive index increasing toward an interface 420S between the dielectric layers 220 and 420 and then decreasing away from the interface 420S. In some embodiments, the gradient index structure 540A has a refractive index decreasing toward the interface 420S between the dielectric layers 220 and 420 and then increasing away from the interface 420S. In some embodiments, the gradient index structure 540A includes gradient index layers 540 and 540′. In some embodiments, the gradient index layer 540 has a refractive index increasing toward the interface 420S or a refractive index decreasing toward the interface 420S. In some embodiments, the gradient index layer 540′ has a refractive index increasing toward the interface 420S or a refractive index decreasing toward the interface 420S. In some embodiments, an equivalent refractive index of the gradient index structure 540A is substantially the same as the refractive index of the waveguide 210 and/or the refractive index of the waveguide 410.

In some embodiments, the gradient index structure 540A includes one or more dielectric layers doped with metal ions, dielectric nanoparticles, or a combination thereof. The metal ions may be or include gold ions, silver ions, copper ions, or other suitable metal ions. The dielectric nanoparticles may be or include silicon oxide. In some embodiments, the gradient index layers 540 and 540′ may be separate dielectric layers each doped with metal ions, dielectric nanoparticles, or a combination thereof. In some embodiments, the gradient index structure 540A may be formed from a portion of the dielectric layer 220 and a portion of the dielectric layer 420. In some embodiments, the gradient index layers 540 and 540′ are formed within the optical connection element 40 and the photonic component 20, respectively, and then the gradient index structure 540A is formed by bonding the gradient index layers 540 and 540′ through bonding the optical connection element 40 to the photonic component 20.

The gradient index structure 540A may be configured to optically couple the photonic component 20 to the optical connection element 40. The gradient index structure 540A may be configured to vertically couple a light between the photonic component 20 and the optical connection element 40.

In some embodiments, each of the optical coupling structure 50 illustrated in FIGS. 2A-2E may be configured as a waveguide interposer. In some embodiments, each of the optical coupling structure 50 illustrated in FIGS. 2A-2E may be configured as a waveguide bridging element between photonic components. In some embodiments, each of the optical coupling structures 50 and 50′ of the optical device 1 may adopt any one of the structures illustrated in FIGS. 2A-2E. In some embodiments, the optical coupling structure 50 and the optical coupling structure 50′ may have different structures depending on the specific applications of the photonic components 20 and 20′.

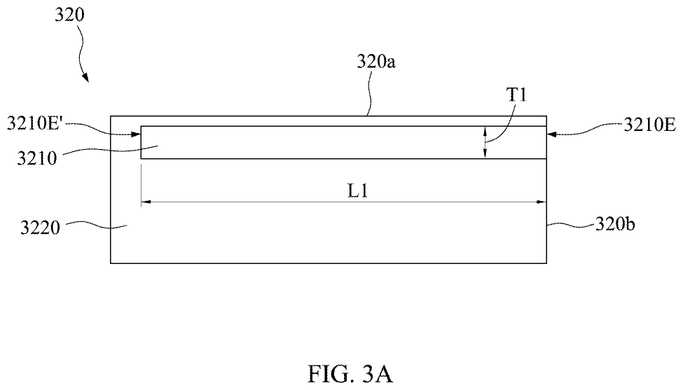

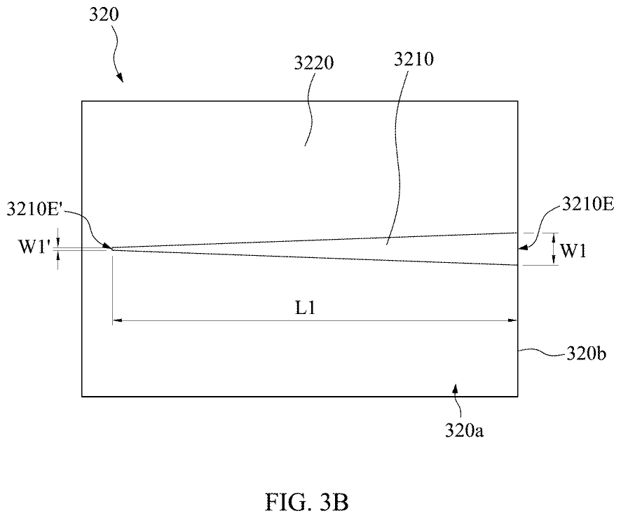

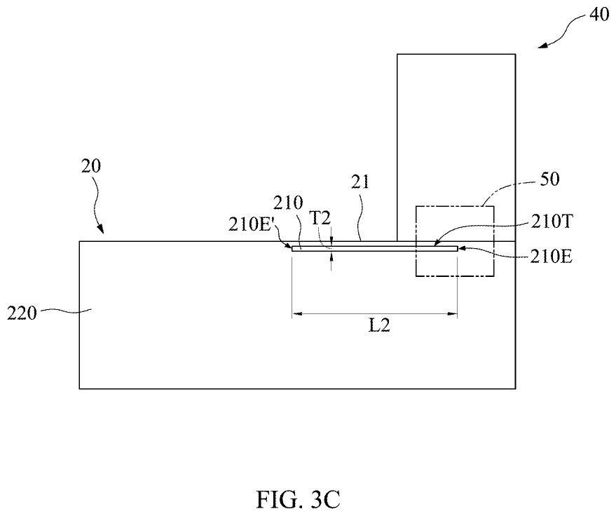

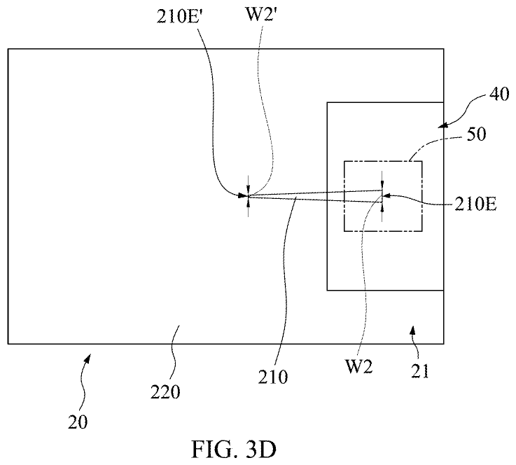

FIG. 3A illustrates a cross-sectional view of a portion of a photonic component 320 in accordance with some embodiments of the present disclosure, and FIG. 3B illustrates a top view of a portion of a photonic component 320 in accordance with some embodiments of the present disclosure.

The photonic component 320 may have a top surface 320a and a lateral surface 320b. In some embodiments, the photonic component 320 includes a waveguide 3210 and a dielectric layer 3220, and the waveguide 3210 is embedded in the dielectric layer 3220. In some embodiments, the waveguide 3210 extends in a direction substantially parallel to the top surface 320a of the photonic component 320, and the waveguide 3210 is configured to optically couple to an external photonic component or element by an edge portion 3210E exposed from the lateral surface 320b. In order to provide a sufficient coupling area for the relatively large external photonic component or element, the edge portion 3210E of the waveguide 3210 has a relatively large width W1, and thus the waveguide 3210 has a relatively large thickness T1. In addition, while the waveguide 3210 includes another edge portion 3210E′ that optically couples to an optical element within the photonic component 320 having a relatively small pitch, the width W1′ of the edge portion 3210E′ may be relatively small. In order to manufacture the waveguide 3210 with a such large difference in widths of the edge portions, the waveguide 3210 has a relatively large length L1. For example, the length L1 may be from about 10 mm to about 15 mm, the width W1 may be equal to or greater than about 5 μm, and the thickness T1 may be from about 3 μm to about 5 μm. With the relatively large thickness T1, the relatively large width W1, and the relatively large length L1, the waveguide 3210 and thereby the photonic component 320 have relatively large sizes.

FIG. 3C illustrates a cross-sectional view of a portion of an optical device in accordance with some embodiments of the present disclosure, and FIG. 3D illustrates a top view of a portion of an optical device in accordance with some embodiments of the present disclosure. For example, FIGS. 3C-3D may illustrate a portion of the optical device 1 including the optical coupling structure 50. In some embodiments, FIGS. 3C-3D may illustrate schematic views of a portion of the optical device 1 including the optical coupling structure 50′ that optically couples the optical connection element 40 to the photonic component 20′.

In some embodiments, the waveguide 210 includes a top portion 210T and edge portions 210E and 210E′, and the top portion 210T faces toward the top surface 21 of the photonic component 20. In some embodiments, the waveguide 210 of the photonic component 20 is optically coupled to the optical connection element 40 through the top surface 21 by the top portion 210T instead of the edge portion 210E. According to some embodiments of the present disclosure, the top portion 210E is a portion of the top surface of the waveguide 210 and has a relatively large area compared to that of the edge portion 210E, and thus the coupling area is relatively large so as to provide a satisfactory coupling efficiency. Since the waveguide 210 is not optically coupled to the optical connection element 40 through the edge portion 210E, thus the edge portion 210E can have a relatively small width W2. In addition, since the difference in the widths W2 and W2′ of the edge portions 210E and 210E′ can be relatively small due to the relatively small width W2, the waveguide 210 may be manufactured to have a relatively small thickness T2 and a relatively small length L2 as well. For example, the length L2 may be less than about 5 mm, the width W2 may be equal to or less than about 0.4 μm, and the thickness T1 may be from about 0.2 μm to about 0.4 μm. Therefore, the as-formed photonic component 20 can have a relatively small size without decreasing the coupling efficiency between the photonic component 20 and the optical connection element 40.

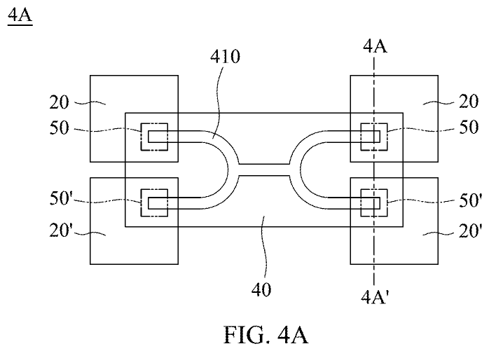

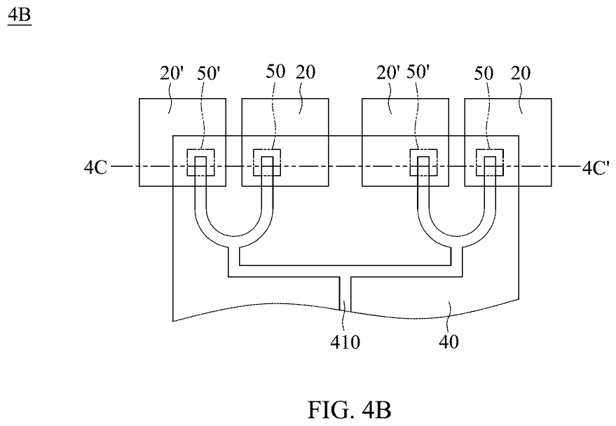

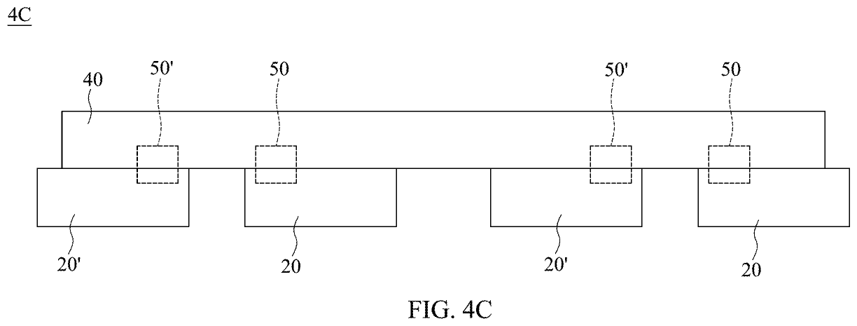

FIG. 4A illustrates a top view of an optical device 4A in accordance with some embodiments of the present disclosure.

In some embodiments, the optical device 4A includes photonic components 20 and 20′, optical coupling structures 50 and 50′, and an optical connection element 40. In some embodiments, the photonic components 20 and 20′ are optically coupled to the waveguide 410 of the optical connection element 40 through the optical coupling structures 50 and 50, respectively. In some embodiments, a portion of the optical device 4A may have a cross-sectional structure along the line 4A-4A′ that is similar to that illustrated in FIG. 1A.

FIG. 4B illustrates a top view of an optical device 4B in accordance with some embodiments of the present disclosure. The optical device 4B is similar to the optical device 4A in FIG. 4A, and the differences therebetween are described as follows.

In some embodiments, the optical device 4B includes photonic components 20 and 20′, optical coupling structures 50 and 50′, and an optical connection element 40. In some embodiments, the photonic components 20 and 20′ are optically coupled to the waveguide 410 of the optical connection element 40 through the optical coupling structures 50 and 50′, respectively. In some embodiments, the optical coupling structures 50 and 50′ are arranged in a row.

FIG. 4C illustrates a cross-sectional view of an optical device 4C in accordance with some embodiments of the present disclosure. In some embodiments, FIG. 4C is a cross-sectional view along a line 4C-4C′ in FIG. 4B. In some embodiments, the optical connection element 40 optically couple the photonic components 20 and 20′ through the optical coupling structures 50 and 50′.

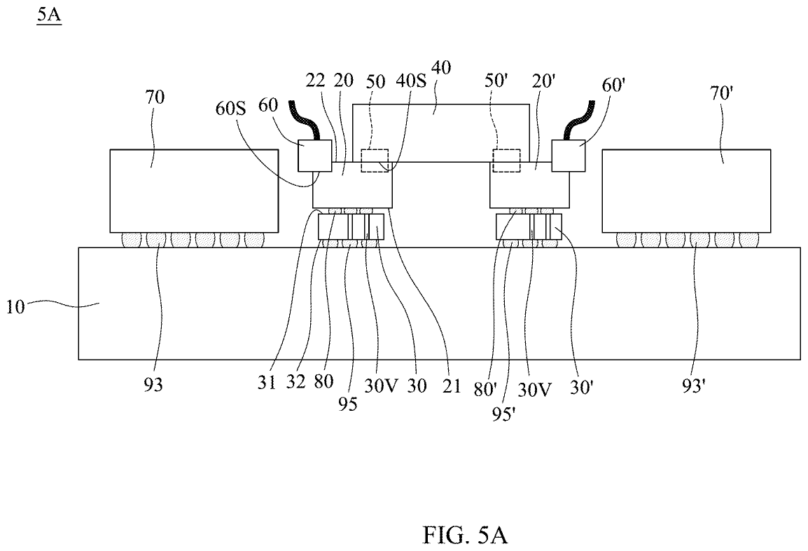

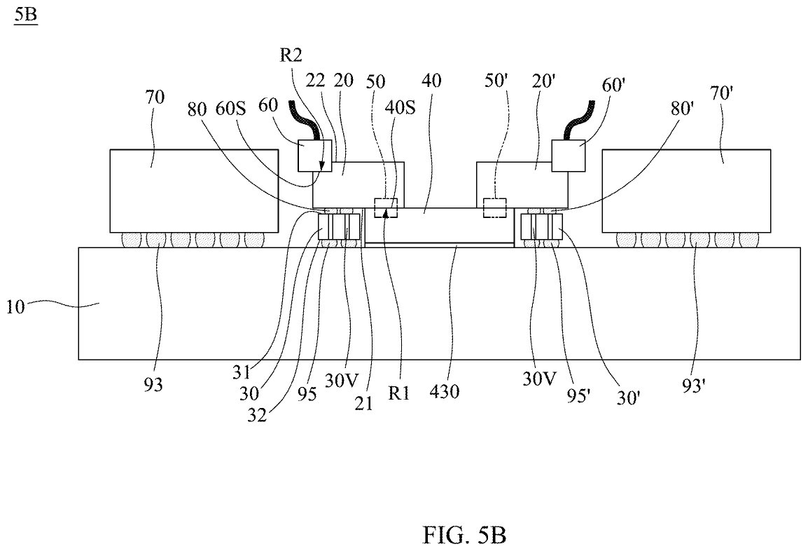

FIG. 5A illustrates a cross-sectional view of an optical device 5A in accordance with some embodiments of the present disclosure. The optical device 5A is similar to the optical device 1 in FIG. 1A, and the differences therebetween are described as follows.

In some embodiments, the electronic component 30 and the optical connection element 40 are disposed on opposite surfaces 21 and 22 of the photonic component 20. In some embodiments, the electronic component 30 includes one or more conductive vias 30V. The conductive via 30V may be configured to transmit an electrical signal from the surface 31 to the surface 32 of the electronic component 30. In some embodiments, the electronic component 30 is electrically connected to the carrier through the electrical contacts 95.

In some embodiments, the electronic component 30′ and the optical connection element 40 are disposed on opposite surfaces 21 and 22 of the photonic component 20′. In some embodiments, the electronic component 30′ includes one or more conductive vias 30V. The conductive via 30V may be configured to transmit an electrical signal from the surface 31 to the surface 32 of the electronic component 30′. In some embodiments, the electronic component 30 is electrically connected to the carrier through the electrical contacts 95′.

The optical component 60 may be disposed on one of the surfaces 21 and 22 of the photonic component 20. In some embodiments, the interface 40S and the interface 60S are configured as different optical coupling interfaces. In some embodiments, the interface 60S is configured to transmit an optical signal between an external element and the photonic component 20. In some embodiments, the interface 40S is configured to transmit an optical signal between the photonic components 20 and 20′ through the optical connection element 40.

According to some embodiments of the present disclosure, since the electronic component 30 is relatively thin compared to the photonic component 20, the conductive via 30V is therefore relatively short so as to provide a relatively short signal path comparted to that of the conductive via 20V of the photonic component 20. Thus, the design of the electronic component 30 including the conductive vias 30V and disposed between the carrier 10 and the photonic component 20 is advantageous to signal transmission. For example, the signal received from the optical component 60 may be transmitted to the carrier 10 directly through the photonic component 20 and the electronic component 30 without passing through any one of the components twice or more. In addition, the electronic component 30 includes circuit layers and does not include waveguides, and thus the formation of the conductive vias 30V within the electronic component 30 is relatively easy compared to the formation of the conductive vias 20V within the photonic component 20 which includes a more complicated structure including both circuit layers and waveguides 210. Therefore, signal transmission through the conductive vias 30V is beneficial to simplifying manufacturing process as well as increasing the yield.

FIG. 5B illustrates a cross-sectional view of an optical device 5B in accordance with some embodiments of the present disclosure. The optical device 5B is similar to the optical device 1 in FIG. 1A, and the differences therebetween are described as follows.

In some embodiments, the electronic component 30 is disposed over the carrier 10 and configured to support the photonic component 20. In some embodiments, the electronic component 30′ is disposed over the carrier 10 and configured to support the photonic component 20′. In some embodiments, the optical connection element 40 is disposed over the carrier 10 and configured to support the photonic components 20 and 20′. In some embodiments, the optical connection element 40 is adhered or attached to the carrier 10 through an adhesive layer 430. The adhesive layer 430 may be or include an insulative layer or a dielectric layer. The adhesive layer 430 may be or include a die attach film (DAF). In some embodiments, the region R1 and the region R2 are at different sides of the photonic component 20. According to some embodiments of the present disclosure, the optical connection element 40 is disposed on the carrier 10 instead of serving as a bridge element over the photonic components 20 and 20′, and thus the carrier 10 can support both the electronic components 30 and 30′ and the optical connection element 40, while the electronic components 30 and 30′ and the optical connection element 40 can further support the photonic components 20 and 20′. Therefore, the overall structural strength of the optical device 5B may be increased.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of said numerical value, such as less than or equal to ±5%, less than or equal to ±4%, less than or equal to ±3%, less than or equal to ±2%, less than or equal to #1%, less than or equal to ±0.5%, less than or equal to ±0.1%, or less than or equal to ±0.05%. For example, two numerical values can be deemed to be “substantially” or “about” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1º, or less than or equal to ±0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to #1°, less than or equal to ±0.5°, less than or equal to ±0.1°, or less than or equal to =0.05°.

Two surfaces can be deemed to be coplanar or substantially coplanar if a displacement between the two surfaces is no greater than 5 μm, no greater than 2 μm, no greater than 1 μm, or no greater than 0.5 μm.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations do not limit the present disclosure. It can be clearly understood by those skilled in the art that various changes may be made, and equivalent components may be substituted within the embodiments without departing from the true spirit and scope of the present disclosure as defined by the appended claims. The illustrations may not necessarily be drawn to scale. There may be distinctions between the artistic renditions in the present disclosure and the actual apparatus, due to variables in manufacturing processes and the like. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it can be understood that these operations may be combined, sub-divided, or re-ordered to form an equivalent method without departing from the teachings of the present disclosure. Therefore, unless specifically indicated herein, the order and grouping of the operations are not limitations of the present disclosure.

What is claimed is:

1. An optical device, comprising:
a first photonic component;
a first electronic component at least partially over the first photonic component; and
an optical connection element at least partially over the first photonic component, the optical connection element being separated from the first electronic component.

2. The optical device as claimed in claim 1, wherein the first electronic component and the optical connection element are disposed on a first surface of the first photonic component.

3. The optical device as claimed in claim 2, further comprising a second photonic component and a second electronic component over the second photonic component, wherein the optical connection element is disposed between the first electronic component and the second electronic component.

4. The optical device as claimed in claim 3, wherein the optical connection element optically couples the first photonic component to the second photonic component.

5. The optical device as claimed in claim 1, further comprising an optical component at least partially disposed over the first photonic component.

6. The optical device as claimed in claim 5, wherein in a cross-sectional view, the first electronic component is disposed between the optical connection element and the optical component.

7. The optical device as claimed in claim 5, wherein the first photonic component comprises a first interface configured to optically couple to the optical connection element and a second interface configure to optically couple to an external element.

8. The optical device as claimed in claim 7, wherein the first interface is configured to transmit a first optical signal between the first photonic component and a second photonic component through the optical connection element, and the second interface is configured to transmit a second optical signal between the external element and the first photonic component.

9. The optical device as claimed in claim 1, wherein the first electronic component and the optical connection element are disposed on opposite surfaces of the first photonic component.

10. The optical device as claimed in claim 1, wherein the first electronic component is electrically connected to the first photonic component, and the optical connection element is optically coupled to the first photonic component.

11. The optical device as claimed in claim 10, further comprising a carrier, wherein the first electronic component comprises a conductive via, and the first electronic component is disposed over the carrier and configured to support the first photonic component.

12. An optical device, comprising:
a first photonic component comprising a first waveguide;
a second photonic component comprising a second waveguide; and
an optical coupling structure between the first photonic component and the second photonic component and configured to optically couple the first waveguide to the second waveguide.

13. The optical device as claimed in claim 12, wherein the optical coupling structure comprises a plurality of waveguide elements between the first photonic component and the second photonic component, and each of the plurality of waveguide elements is arranged one by one to transmit a light from the first waveguide through the waveguide elements to the second waveguide.

14. The optical device as claimed in claim 12, wherein the optical coupling structure comprises:
a first optical microstructure on the first waveguide;
a second optical microstructure on the second waveguide; and
an optical interposer between the first optical microstructure and the second optical microstructure, wherein the first optical microstructure and the second optical microstructure overlap vertically, and a light is transmitted from the first waveguide through the first optical microstructure, the optical interposer, and the second optical microstructure to the second waveguide.

15. The optical device as claimed in claim 12, wherein the optical coupling structure comprises a gradient index structure contacting the first waveguide and the second waveguide.

16. The optical device as claimed in claim 12, wherein the optical coupling structure comprises a light propagation element contacting the first waveguide and the second waveguide, and the light propagation element defines a light propagation direction substantially perpendicular to at least one of an extending direction of the first waveguide and an extending direction of the second waveguide.

17. An optical device, comprising:
a photonic component comprising a first region and a second region;
a first optical structure optically coupled to the first region of the photonic component; and
a second optical structure optically coupled to the second region of the photonic component,
wherein a density of input/output (I/O) terminals at the first region is greater than a density of I/O terminals at the second region.

18. The optical device as claimed in claim 17, wherein a first diameter of one of the I/O terminals at the first region is less than a second diameter of one of the I/O terminals at the second region.

19. The optical device as claimed in claim 17, wherein the first region and the second region are at different sides of the photonic component.

20. The optical device as claimed in claim 17, wherein the first region is configured to provide a different optical coupling type from the second region.
